(19) United States
(12) Patent Application Publication
(10) Pub. No.: US 2019/0071533 A1
(43) Pub. Date: Mar. 7, 2019

(54) POLYESTER POLYOLS IMPARTING IMPROVED FLAMMABILITY PROPERTIES

(71) Applicant: Stepan Company, Northfield, IL (US)

(72) Inventors: Sarah Wolek, Arlington Heights, IL (US); Warren A. Kaplan, Libertyville, IL (US); Laura Schreiner, Palatine, IL (US); Chunhua Yao, Carmel, IN (US); David J. Norberg, Grayslake, IL (US)

(21) Appl. No.: 16/179,690

(22) Filed: Nov. 2, 2018

Related U.S. Application Data
(62) Division of application No. 14/853,659, filed on Sep. 14, 2015.
Application No. 14/853,659 is a continuation of application No. PCT/US14/22573, filed on Mar. 10, 2014.
(60) Provisional application No. 61/792,692, filed on Mar. 15, 2013.

(51) Int. Cl. C08G 18/42; C08L 75/04; C08G 18/54; C08G 18/16; C08G 18/18; C08G 63/46; C08G 63/183; C08G 63/181; C08G 18/76; C08G 18/72; C08G 18/09; C08G 18/48; C08G 18/40; C08G 18/22; C08G 101/00

(52) U.S. Cl. CPC C08G 18/4263; C08G 2105/02; C08G 18/544; C08G 18/163; C08G 18/1808; C08G 18/1816; C08G 63/46; C08G 63/183; C08G 63/181; C08G 18/7664; C08G 18/72; C08G 18/092; C08G 18/4829; C08G 18/4288; C08G 18/4213; C08G 18/4211; C08G 18/4027; C08G 18/4018; C08G 18/225; C08G 2101/00; C08G 2101/0025; C08G 2101/005; C08L 75/04

(57) ABSTRACT

An aromatic polyester polyol having a nominal functionality of at least about 2 is produced from the esterification reaction of a phthalate-based composition containing less than 50 mol % of ortho-phthalic acid or phthalic anhydride, with a hydroxyl material containing at least 20 mol % of at least one branched aliphatic diol, and optionally transesterified with at least one hydrophobic material. The polyester polyol has improved shelf-life stability as demonstrated by the polyester polyol remaining clear and homogeneous for at least 6 months when stored at room temperature. The polyester polyol, when incorporated into a polyol foam-forming resin composition in an amount of at least 40 wt %, results in polyurethane and polyisocyanurate foams that exhibit low smoke and weight loss upon burning conditions.

### RELATED APPLICATIONS

This application is a division of and claims priority to U.S. application Ser. No. 14/853,659, filed on Sep. 14, 2015, which application is a continuation of and claims priority to PCT Patent Application PCT/US14/22573 having an International filing date of Mar. 10, 2014, which claims priority to U.S. Provisional Application No. 61/792,692, filed Mar. 15, 2013. The contents of the applications referred to above are hereby incorporated by reference.

### BACKGROUND OF THE INVENTION

The present technology relates to polyester polyol compositions for use in polyurethane and polyisocyanurate foams, and in particular relates to polyester polyol compositions that impart improved flammability properties to the polyurethane and polyisocyanurate foams.

Aromatic polyester polyols are widely used in the manufacture of polyurethane and polyisocyanurate foams and resins. Typically, such polyester polyols are produced by esterification of phthalic acid(s) or phthalic acid anhydride with an aliphatic polyhydric alcohol. Useful phthalic acid-based materials include orthophthalic acid or anhydride, isophthalic acid, terephthalic acid, polyalkylene terephthalates, especially polyethylene terephthalate (PET), or PET residues or scraps.

Polyester polyols based on terephthalic acid are generally known to have improved flame resistance and low smoke generation properties compared to ortho-phthalic acid-based polyester polyols when incorporated into polyurethane and polyisocyanurate foams. However, a significant drawback of polyester polyols with high terephthalic acid content is their reduced shelf-life stability as demonstrated by a tendancy to become cloudy over time. It would be desirable to provide a polyester polyol, based on high terephthalic acid content that can impart improved flammability performance to polyurethane and polyisocyanurate foams, yet also have improved shelf-stability.

### BRIEF SUMMARY OF THE INVENTION

In one aspect, the present technology provides a polyester polyol having a nominal functionality of at least about 2, comprising the esterification reaction product of (a) a phthalate-based composition comprising less than 50 mol % of phthalic acid or phthalic anhydride, and (b) a hydroxyl-containing composition comprising at least 20 mol % of at least one branched aliphatic diol; the esterification reaction product being optionally transesterified with at least one hydrophobic material, and optionally blended with at least one non-ionic surfactant, wherein the polyester polyol remains homogeneous for a period of at least 6 months when stored at 20-30° C.

In another aspect, the present technology provides a polyester polyol resin blend composition comprising:
(a) at least 40% by weight of the resin blend of a polyester polyol that is the reaction product of
   i. a phthalate-based composition comprising less than 50 mol % of ortho-phthalic acid or ortho-phthalic anhydride; and
   ii. a hydroxyl-containing composition comprising at least 20 mol % of at least one branched aliphatic diol;
   iii. optionally transesterified with at least one hydrophobic material;
   iv. optionally blended with at least one non-ionic surfactant;
(b) at least one blowing agent;
(c) optionally, at least one catalyst; and
(d) optionally, at least one flame retardant.
(e) optionally, at least one surfactant
(f) other foam ingredients (additives, fillers, pigments, etc.)

In a further aspect, the present technology provides a polyurethane or polyisocyanurate foam that exhibits low smoke and weight loss characteristics upon burning conditions.

### BRIEF DESCRIPTION OF SEVERAL VIEWS OF THE DRAWINGS

[Not Applicable]

### DETAILED DESCRIPTION OF THE INVENTION

The polyester polyols of the present technology comprise the reaction product of (a) a phthalic acid-based material having an ortho-phthalate content of less than 50 mol %, based on the total content of phthalate-based material, with (b) at least one hydroxyl-containing material containing at least 20 mol % of at least one branched aliphatic diol, based on the total content of hydroxyl-containing material, optionally (c) a hydrophobic material and optionally (d) a non-ionic surfactant. The polyester polyols are further combined with one or more blowing agents, and optionally one or more catalysts and auxiliary components or additives to form a polyol resin composition. The polyol resin composition can be reacted with an isocyanate to produce polyurethane or polyisocyanurate foams.

### Phthalic Acid-Based Material

The polyester polyols of the present technology are prepared from a phthalic acid-based material. As used herein, “phthalic acid-based material” or “phthalate-based material” means an aromatic dicarboxylic acid or a derivative thereof. Examples of phthalic acid-based material include, but are not limited to, ortho-phthalic acid, isophthalic acid, terephthalic acid, methyl esters of orthophthalic, isophthalic or terephthalic acid, phthalic anhydride, dimethyl terephthalate, polyethylene terephthalate, trimellitic anhydride, and pyromellitic dianhydride. An important aspect of the present technology is that the polyester polyol contain less than 50 mol % of ortho phthalic-acid based material, based on the total phthalic-acid based material present in the polyester polyol. Limiting the ortho-phthalic acid content to less than 50 mol %, for example by limiting the amount of ortho-phthalic acid or phthalic anhydride used to prepare the polyester polyol, results in a polyester polyol that imparts improved flammability performance characteristics to polyurethane and polyisocyanurate foams. In one embodiment, the ortho-phthalic acid content is no more than 35 mol % of the phthalic acid-based material. The phthalic acid-based material advantageously comprises greater than 50 mol % of iso and/or terephthalic acid-based content.

### Hydroxyl-Containing Material

The phthalic acid-based material is reacted with a hydroxyl-containing material to prepare the polyester polyols of the present technology. An important feature of the present technology is that the hydroxyl-containing material comprises at least 20 mol % of at least one non-linear (branched) aliphatic diol By “non-linear” or “branched” is meant that the aliphatic diol has one or more alkyl groups bonded to one or more alkylene carbons of the aliphatic carbon chain, thereby creating tertiary or quaternary carbon atom(s) within the chain. Thus, for most branched diols contemplated herein, there will be at least one carbon atom that is not a primary or secondary carbon. Dipropylene glycol and 1,2-propylene glycol, although containing only primary and secondary carbons, are nevertheless intended to be included in the contemplated branched aliphatic diols.

It has been found that the incorporation of a branched aliphatic diol into the polyester polyol significantly improves the shelf-life stability of polyester polyols containing less than 50 mol % of ortho-phthalate-containing material. Significant improvement in shelf-life stability is demonstrated by the polyester polyol remaining clear and homogeneous, with no indication of haze or separation, for a period of at least 6 months when stored at room temperature (20-30° C.). Examples of suitable branched aliphatic diols include, but are not limited to, neopentyl glycol, 2-methyl-1,3-propandiol, 2-methyl-2,4-pentandiol, 2-butyl-2-ethyl-1,3-propandiol, 2-ethyl-1,3-hexandiol, 2,4-diethyl-1,5-pentandiol, 1,2-propylene glycol and dipropylene glycol. Mixtures of branched aliphatic diols can be employed. In one embodiment, the branched aliphatic diol is 2-methyl-1,3-propandiol. The amount of branched aliphatic diol can be 20 mol % to 100 mol %, preferably 20 mol % to 80 mol %, most preferably 20 mol % to 50 mol %.

Mixtures of diols can be employed, provided that at least 20 mol % of the diol mixture is at least one branched aliphatic diol. Other diols that can be used in combination with the branched aliphatic diols are low molecular weight diols having an average molecular weight of less than about 200. Examples of such diols include ethylene glycol, diethylene glycol, triethylene glycol, 1,3-propane glycol, butylene glycols, 1,2-cyclohexandiol, and polyoxyalkylene polyols derived from the condensation of alkylene oxide.

In addition, the hydroxylated material can include low molecular weight higher functional polyols. Examples of such polyols include glycerol, 1,1,1-trimethylolpropane, 1,1,1-trimethylolethane, and pentaerythritol.

### Hydrophobic Material

Optionally, the polyester polyols can be transesterified with a hydrophobic material. In some embodiments, the polyester polyol comprising at least 20 mol % of a branched diol may have a viscosity that is higher than a polyester polyol containing only a linear diol, such as diethylene glycol. Transesterification of the polyester polyol with a hydrophobic material, such as a fatty carboxylic acid or a natural oil, can reduce the viscosity of the polyester polyol.

The term “hydrophobic material” as used herein means a compound or mixture of compounds which contains one or more substantially non-polar organic moieties. The hydrophobic materials are substantially water insoluble and generally contain at least one group capable of being esterified or transesterified, such as a carboxylic acid group, a carboxylic acid ester group, or a hydroxyl group. Generally, the hydrophobic materials used herein are non-phthalic acid derived materials.

The hydrophobic material of the present technology includes, for example, carboxylic acids (especially fatty acids), lower alkanol esters of carboxylic acids (especially fatty acid methyl esters), fatty acid alkanolamides, and natural oils (e.g., triglycerides (especially fats and oils)) derived from renewable resources. The natural oils may be unmodified (e.g., do not contain a hydroxyl functional group), functionalized (natural oil polyols) or a combination thereof. Suitable natural oils for practice of the present technology include, for example, triglyceride oils, coconut oil, cochin oil, corn oil, cottonseed oil, linseed oil, olive oil, palm oil, palm kernel oil, peanut oil, soybean oil, sunflower oil, tall oils, tallow, lesquerella oil, tung oil, whale oil, tea seed oil, sesame seed oil, safflower oil, rapeseed oil, fish oils, derivatives thereof, and combinations thereof.

Suitable derivatives thereof of natural oils include, but are not limited to, carboxylic acids (e.g., fatty acids, lower alkanol esters (e.g., fatty acid methyl esters) and fatty acid alkanolamides. Examples of fatty acids include, but are not limited to, caproic, caprylic, capric, lauric, myristic, palmitic, stearic, oleic, linoleic, linolenic, ricinoleic, and mixtures thereof. Other suitable acids are dimer acid and 2-ethylhexanoic acid. Examples of fatty acid methyl esters include, but are not limited to, methyl caproate, methyl caprylate, methyl caprate, methyl laurate, methyl myristate, methyl palmitate, methyl oleate, methyl stearate, methyl linoleate, methyl linolenate, and mixtures thereof. Examples of fatty alkanolamides include, but are not limited to, tall oil fatty acid diethanolamide, lauric acid diethanolamide, and oleic acid monoethanolamide.

Examples of alkyl alcohols include decyl, oleyl, cetyl, isodecyl, tridecyl, lauryl alcohols, and mixtures thereof.

Presently preferred types of hydrophobic materials include lower alkylesters of fatty acids, fats, and oils. In some embodiments, the hydrophobic material is soybean oil. The hydrophobic material is present in the polyester polyols in an amount of about 0 to 5 mol %, preferably 0 to 2 mol %.

### Non-Ionic Surfactants

Optionally, the polyester polyols can be blended with at least one non-ionic surfactant. Nonionic surfactants are those compounds that contain one or more hydrophobic moieties and one or more hydrophilic moieties and which have no moieties that dissociate in aqueous solution or dispersion into cations and anions.

The nonionic surfactant added to the polyester polyol can be, for example, a polyoxyalkylene nonionic surfactant. While nearly any nonionic surfactant compound can be employed, in general, in the practice of the present technology, it is preferred that the nonionic surfactant be a polyoxyalkylene surfactant which contains an average of from about 4 to about 240 individual oxyalkylene groups per molecule with the oxyalkylene groups typically being selected from the group consisting of oxyethylene and oxypropylene. Polyoxyalkylene nonionic surfactants may be based on any starting material which bears groups with hydrogen atoms reactive to alkoxylation. This includes hydroxyl, carboxyl, thiol, and primary and secondary amine groups.

The hydrophobic portion of a nonionic surfactant is preferably derived from at least one starting compound which is selected from the group consisting of:
(a) alcohols containing from about 4 to 18 carbon atoms each,
(b) fatty amides containing from about 6 to 18 carbon atoms each in the fatty acid moiety,
(c) fatty amines containing from about 6 to 18 carbon atoms each,
(d) fatty acids containing from 6 to 18 carbon atoms each,
(e) phenols and/or alkyl phenols wherein the alkyl group contains from about 4 to 16 carbon atoms each,
(f) fats and oils containing from 6 to about 60 carbon atoms each,
(g) polyoxypropylene glycols containing from 10 to 70 moles of propylene oxide,
(h) polyoxybutylene glycols containing from 10 to 70 moles of butylene oxide, and
(i) mixtures thereof.

In making a nonionic surfactant, such a starting compound is sufficiently alkoxylated to provide a desired hydrophilic portion. Depending on the alkoxylation reactant proportions used, the starting compound is alkoxylated on average with about 3 to 125 moles of alkylene oxide per mole of starting compound, where the alkoxylation material is preferably selected from the group consisting of ethylene oxide, propylene oxide, and mixtures thereof. Examples of nonionic surfactants contemplated include, but are not limited to, the reaction product of one mole of Neodol® 45 (a linear C₁₄-C₁₅ alcohol available from Shell Chemical Co.), 14 moles of propylene oxide (PO), and 11 moles of ethylene oxide (EO); the reaction product of one mole of castor oil and 36 moles of EO; the reaction product of one mole of tallowamine and 10 moles of EO; the reaction product of one mole of nonyl phenol and 10 moles of EO; the reaction product of one mole of nonyl phenol, 30 moles of PO, and 30 moles of EO; the reaction product of one mole of tall oil fatty acid and 12 moles of EO; and the reaction product of one mole of lauryl alcohol and 8 moles of EO.

One class of nonionic surfactants employable in the present technology is characterized by the formula (1):

RO(CH₂CH₂O)ₙH (1)

where:

R is a radical selected from the group consisting of alkyl phenyl radicals wherein the alkyl group in each such radical contains about four to eighteen carbon atoms, and alkyl radicals each containing from six through twenty carbon atoms, and n is a positive whole number from 3 to 125.

Some of the nonionic surfactants employable in the practice of the present technology can be characterized by containing block units of ethylene oxide in combination with block units of propylene oxide or butylene oxide. Thus the hydrophobic part of a molecule may contain recurring butylene oxide or propylene oxide units or mixed units of butylene oxide and propylene oxide. Minor amounts of ethylene oxide may also be present within the blocks of propylene oxide or butylene oxide. Thus, the hydrophobic portion may consist of a polyoxyalkylene block derived from alkylene oxides with at least three carbon atoms, an alkyl, aryl, or alkaryl hydrocarbon group with at least six carbon atoms, as for instance from a fatty alcohol, or a combination of one or more such polyoxyalkylene blocks and one or more such hydrocarbon groups. Typically, the hydrophilic portion of the nonionic surfactants employed herein is comprised of ethylene oxide units.

The polyester polyols of the present technology advantageously have an average functionality of about 1.8 to about 3.0, preferably 1.8 to about 2.5. The aromatic polyester polyol contains an amount of phthalic acid-based material relative to an amount of hydroxylated material to give an average hydroxyl value of 150 to 500, alternatively 200 to 350, alternatively 220 to 350, and an acid value of 0.05 to about 5.0, alternatively, about 0.25 to about 3.0, alternatively about 0.5 to about 1.5. The polyester polyols of the present technology have a shelf-life stability of at least six months, as demonstrated by a lack of haze and phase separation in the polyester polyol.

### Resin Blends

The polyester polyol of the present technology is incorporated into a resin blend composition or “B component” which is reacted with an isocyanate to make a polyurethane or polyisocyanurate foam. The resin blend composition comprises the polyester polyol of the present technology in an amount of at least 40% by weight of the resin composition. It has been found that when the polyester polyol comprises at least 40% by weight of the resin composition, the resulting polyurethane foam or polyurethane-modified isocyanurate foam has improved flammability performance characteristics, as demonstrated, for example, by low smoke and low weight loss upon burning conditions, or through less thickness loss and more weight retained in hot plate testing and thermogravity analysis, respectively. Generally, the polyester polyol can comprise up to about 80% by weight of the resin blend.

The resin blend composition may optionally comprise other polyols in addition to the polyester polyol. Examples of other types of polyols include polyether polyols, thioether polyols, amine-initiated polyether polyols, Mannich polyols, polyester amides, polyacetals, and aliphatic polycarbonates containing hydroxyl groups; polyoxyalkylene polyether polyols, amine terminated polyoxyalkylene polyethers; non-aromatic polyester polyols, graft dispersion polyols, and polyester polyether polyols.

The resin blend also comprises one or more blowing agents, optionally one or more catalysts, and optionally one or more other auxiliary components or additives, including surfactants and/or flame retardants.

Suitable blowing agents for use in the preparation of polyurethane or polyisocyanurate foams are known to those familiar with the technology and include aliphatic or cycloaliphatic C4-C7 hydrocarbons, water, mono- and polycarboxylic acids having a molecular weight of from 46 to 300, salts of these acids, and tertiary alcohols, fluorocarbons, chlorofluorocarbons, hydrochlorofluorocarbons, hydrofluorocarbons (HFC's ex. 245fa, 365mcf), halogenated hydrocarbons, hydrohaloolefins (HFO). Suitable blowing agents are further described, for example, in U.S. Pat. No. 5,922,779, which is herein incorporated by reference. Also, mixtures and combinations of different blowing agents can be used.

The resin blends of the invention optionally contain catalysts to accelerate the reaction with the polyisocyanate. Suitable catalysts include but are not limited to salts of organic carboxylic acids, for example sodium salts, ammonium salts, and preferably potassium salts. Examples include trimethyl-2-hydroxypropyl ammonium formate, trimethyl-2-hydroxypropyl ammonium octanoate, potassium formate, potassium 2-ethylhexanoate, and potassium acetate. Tin (II) salts of organic carboxylic acids are often used as catalysts as well, which include, for example, tin (II) acetate, tin (II) octoate, tin (II) ethylhexanoate and tin (II) laurate, and the dialkyltin (IV) salts of organic carboxylic acids, e.g., dibutyltin diacetate, dibutyltin dilaurate, dibutyltin maleate, and dioctyltin diacetate.

The organic metal compounds can be used alone or preferably in combination with strongly basic amines. Tertiary amines are used to promote urethane linkage formation and the reaction of isocyanate with water to generate carbon dioxide. The tertiary amines can also be used alone as a catalyst, particularly in polyurethane foam applications. Tertiary amines include but are not limited to triethylamine, 3-methoxypropyldimethylamine, triethylenediamine, pentamethyldiethylenetriamine, and bis(dimethylaminopropyl)urea, tributylamine; dimethylbenzylamine; N-methylmorpholine; N-ethylmorpholine; N-cyclohexylmorpholine; N,N,N′,N′-tetramethylethylenediamine; N,N,N′,N′-tetramethylbutanediamine; N,N,N′,N′-tetramethylhexane-1,6-diamine; bis(dimethylaminoethyl)ether; dimethylpiperazine; 1,2-dimethylimidazole; 1-azabicyclo(3,3,0)octane and 1,4-diazabicyclo(2,2,2)octane. Additionally, one can use alkanolamine compounds such as triethanolamine; triisopropanolamine; N-methyldiethanolamine and N-ethyldiethanolamine and dimethylethanolamine.

Particularly preferred catalysts include tertiary amine catalysts, potassium 2-ethylhexanoate, available commercially from Air Products and Chemicals under the trade name Dabco K-15 Catalyst; pentamethyldiethylenetramine, available commercially from Air Products and Chemicals under the trade name Polycat 5 Catalyst; and dimethylcyclohexylamine, available commercially from Air Products and Chemicals under the trade name Polycat 8 Catalyst.

Additional suitable catalysts include tris(dialkylaminoalkyl)-s-hexahydrotriazines, in particular tris(N,N-diamethylaminopropyl)-s-hexahydrotriazine; tetraalkylammonium hydroxides such as tetramethylammonium hydroxide; alkali metal hydroxides such as sodium hydroxide and alkali metal alkoxides such as sodium methoxide and potassium isoproproxide and also alkali metal salts of long-chain fatty acids having from 10 to 20 carbon atoms and possibly lateral OH groups in combinations of the organic metal compounds and strongly basic amines.

Catalysts, if employed, are added to the resin blend in an amount of from about 0.05 to 5 weight %, and preferably from about 0.1-2.0 weight %. The amount of catalyst based on the weight of all foaming ingredients is from about 0.5 to about 5 percent by weight, and preferably from about 1 to about 4 percent by weight.

The resin blend compositions can also contain optional additives. For example, the additives can include one more of a cell stabilizing surfactant, flame retardants, pigments, and fillers.

The resin blend of the present technology can be mixed with an isocyanate to produce a polyurethane or polyisocyanurate foam. The isocyanate component is preferably a polyisocyanate, herein defined as having two or more isocyanate functionalities. Examples of these include conventional aliphatic, cycloaliphatic, and preferably aromatic isocyanates. Specific examples include: alkylene diisocyanates with 4 to 12 carbons in the alkylene radical such as 1,12-dodecane diisocyanate, 2-ethyl-1,4-tetramethylene diisocyanate, 2-methyl-1,5-pentamethylene diisocyanate, 1,4-tetramethylene diisocyanate and 1,6-hexamethylene diisocyanate; cycloaliphatic diisocyanates such as 1,3- and 1,4-cyclohexane diisocyanate as well as any mixtures of these isomers, 1-isocyanato-3,3,5-trimethyl-5-isocyanatomethylcyclohexane (isophorone diisocyanate), 2,4- and 2,6-hexahydrotoluene diisocyanate and the corresponding isomeric mixtures 4,4′-2,2′- and 2,4′-dicyclohexylmethane diisocyanate as well as the corresponding isomeric mixtures and preferably aromatic diisocyanates and polyisocyanates such as 2,4- and 2,6-toluene diisocyanate and the corresponding isomeric mixtures, and 2,2′-diphenylmethane diisocyanate and the corresponding isomeric mixtures, mixtures of 4,4′-, 2,4′-, and 2,2-diphenylmethane diisocyanates and polyphenylene polymethylene polyisocyanates (crude MDI).

In one embodiment, the polyisocyanate component used in conjunction with the resin blend of the present technology is a polymeric diphenylmethane diisocyanate (MDI) having a nominal functionality of approximately 2.7-3.0, and an NCO content of approximately 31 weight percent.

Generally, the isocyanate and the resin blend are combined at an isocyanate index of about 90 to about 150, preferably about 100 to about 125, for polyurethane foam and from about 150 to about 400, preferably about 250 to about 350 for polyisocyanurate foam. The polyester polyols of the present technology can be used to make polyurethane and polyisocyanurate foams for both rigid and non-rigid foam uses. For example, they can be used to make polyurethane spray foams, pour-in-place foams, bunstock foams and laminates.

The polyester polyols of the present technology can also be used in polyurethane non-foam applications. For example, the polyester polyols can be used in sealants, elastomers, coatings or adhesive products.

The presently described technology and its advantages will be better understood by reference to the following examples. These examples are provided to describe specific embodiments of the present technology. By providing these specific examples, the inventors do not limit the scope and spirit of the present technology.

### Examples

The following components were used in the following examples:

STEPANPOL® PS-2352, a PA-DEG polyester polyol available from Stepan Company, with nominal OH value 240 mg KOH/g and nominal functionality of 2.0

STEPANPOL® PS-3024: Terephthalic acid and >/=50 mol % ortho-phthalic acid based polyol available from Stepan Company with nominal OHV of 315 mgKOH/g and nominal functionality of 2.4 with <20 mol % branched glycol

Polyether Polyol 1: Mannich Polyol Jeffol® R-425X from Huntsman

Polyether Polyol 2: Sucrose Polyol Multranol® 4030 from Bayer Material Science

Polyol 1: Terephthalic acid and ortho-phthalic based polyol (<50 mol %) with nominal OHV of 250 mgKOH/g and nominal functionality of 2.0 and >20 mol % branched diol

Polyol 2: Terephthalic acid based polyol with nominal OHV of 350 mgKOH/g and nominal functionality of 2.2 and >20 mol % branched diol

Polyol 3: Isophthalic acid based polyol with nominal OHV of 250 mgKOH/g and nominal functionality of 2.0 and >20 mol % branched diol

Polyol 4: Terephthalic acid and ortho-phthalic acid based polyol (<50 mol %) with nominal OHV of 250 mgKOH/g and nominal functionality of 2.0 and >20 mol % branched diol

Polyol 5: Polyol blend of polyol 1 and Nonionics 1, with OHV of 240 mgKOH/g

Polyol 6: Polyol blend of Polyol 1 with Nonionics 2, with OHV of 240 mgKOH/g

Comparative Example Polyol 1: Terephthalic acid and phthalic acid based polyol with OHV of 350 mgKOH/g and nominal functionality of 2.4 with no branched diol

Comparative Example Polyol 2: Terephthalic acid and phthalic acid based polyol with OHV of 315 mgKOH/g and nominal functionality of 2.2

Comparative Example Polyol 3: Terephthalic acid and phthalic acid based polyol with OHV of 350 mgKOH/g and nominal functionality of 2.2

Nonionic 1 and 2: polyalkoxylate material with MW 3000-6000

Polycat® 5: Pentamethyldiethylenetriamine, a catalyst from Air Products and Chemicals, Inc.

Dabco® TMR-3: Quarternary Ammonium Salt trimerization catalyst from Air Products and Chemicals, Inc.

Curithane® 52: Amine trimerization catalyst from Air Products and Chemicals, Inc.

Polycat® 8: Dimethylcyclohexylamine, a catalyst from Air Products and Chemicals, Inc.

Dabco® K-15: a solution of potassium 2-ethylhexanoate in Diethylene Glycol from Air Products and Chemicals, Inc.

Polycat® 46: a solution of potassium acetate in Ethylene glycol from Air Product and Chemicals, Inc

Catalyst blend: the blend of Polycat®5, Dabco®K-15 and Polycat®46 at wt % of (7.6/84/8.4)

TEGOSTAB® B-8465: a silicone cell-stabilizing surfactant from Evonik Industries AG

TEGOSTAB® B-8537: a silicone cell-stabilizing surfactant from Evonik Industries AG

Dabco® DC 193: a silicone cell-stabilizing surfactant from Air Products and Chemicals, Inc.

Mondur® M-489: a 3.0-functional polymeric diphenylmethane diisocyanate (PMDI) from Bayer Material Science LLC

Mondur® MR Light: a 2.7 functional polymer diphenylmethane diisocyanate (PMDI) from Bayer Material Science LLC

Saytex® RB-7980: a blend of Saytex RB-79 flame retardant polyol and a liquid phosphate ester from Albermarle Corporation

Fyrol® PCF: Tris (2-chloroisopropyl) phosphate, a flame retardant produced by Israel Chemicals, Ltd. (ICL)

Fyrol® PNX: Oligomeric ethylene phosphate, a flame retardant produced by Israel Chemical, Ltd (ICL)

Triethyl Phosphate (TEP): a flame retardant obtained from Acros.

N-Pentane: Hydrocarbon blowing agent from Chevron Phillips Chemical Company

### General Procedure for Preparing Polyester Polyols

The phthalate-based material, and hydroxyl-containing material are charged to a reactor affixed with mechanical stirring, nitrogen inlet, packed distillation column, condenser with receiver, and temperature control. The temperature is set to 210° C. and the starting materials are heated and stirred under nitrogen sparge. The esterification reaction is continued with reflux until the material is clear and homogenous and the distillate rate slows. The Acid Value and OH Value are measured, and heating is continued, with further addition of glycol, if needed, until a desired OH Value is obtained. If used, natural oils or fatty acids are added and transesterified into the reaction mix by continued heating until the reaction is complete. Optionally, non-ionic surfactants can be blended into the reacted product.

Polyester polyols were made by the general procedure outlined above and have the compositions as indicated in Table 1.

TABLE 1

| | Values are in mol % | | | | | | |
|---|---|---|---|---|---|---|---|
| | Example Polyols | | | | Comparative Examples | | |
| Polyol Example | 1 | 2 | 3 | 4 | 1 | 2 | 3 |
| OHV | 250 | 350 | 250 | 250 | 350 | 315 | 350 |
| Functionality | 2.0 | 2.2 | 2.0 | 2.0 | 2.4 | 2.2 | 2.2 |
| Acids | | | | | | | |
| Phthalic | 12.6 | | | 12.6 | 8.7 | 12.4 | 8.1 |
| Anhydride | | | | | | | |
| Terephthalic Acid | 23.5 | 33.7 | | 23.3 | 26.0 | 23.0 | 24.5 |
| Isophthalic Acid | | | 36.2 | | | | |
| Glycols | | | | | | | |
| (*branched diol) | | | | | | | |
| Diethylene Glycol | 40.8 | 37.8 | 40.9 | 41.0 | 51.4 | 58.8 | 58.6 |
| Glycerin | | 7.4 | | | 13.3 | 5.8 | |
| Trimethylol | | | | | | | 8.0 |
| Propane | | | | | | | |
| 2-Methyl-1,3- | 22.0 | 20.4 | 21.9 | | | | |
| Propanediol* | | | | | | | |
| Neopentyl | | | | 22.1 | | | |
| Glycol* | | | | | | | |
| Fatty Acid | | | | | | | |
| Modifier | | | | | | | |
| Soybean Oil | 1.1 | 0.7 | 0.95 | 1.0 | 0.59 | | 0.6 |
| Total | 100 | 100 | 100 | 100 | 100 | 100 | 100 |

The polyester polyols listed in Table 1 were evaluated for shelf life stability. Shelf life stability was tested by adding a 4 oz sample of the polyol to a clear glass jar, capping it, and leaving it on the shelf under ambient conditions, (20° C.-30° C.), checking daily for the first week and then weekly for signs of haze crystal formation or separation. Haze is visible to the naked eye and first appears as ‘wisps’ or ‘clouds’ forming in the otherwise clear polyol. The shelf life test ends when the first signs of haze or separation appear. Over time, the polyol will change from being completely clear to completely opaque. The results of the shelf life stability study are shown in Table 2.

TABLE 2
Shelf-Life Stability

| | Branched diol | |
|---|---|---|
| Polyester Polyol | (Mol % Amount) | Appearance |
| Example 1 | 22.0 | clear >9 months |
| Example 2 | 20.4 | clear >1 year |
| Example 3 | 21.9 | clear >6 months |
| Example 4 | 22.1 | clear >6 months |
| Comparative Polyol 1 | 0.0 | haze after 14 weeks |
| Comparative Polyol 2 | 0.0 | haze after 11 weeks |
| Comparative Polyol 3 | 0.0 | haze after 5 months |

From the results in Table 2, it can be seen that when at least 20 mol % of a branched diol was substituted for a linear diol, such as diethylene glycol, in polyester polyols containing at least 50 mol % terephthalic or isophthalic acid, the polyester polyols remained homogeneous and haze free for at least 6 months. In comparison, polyester polyols comprising diethylene glycol with glycerine or trimethylolpropane, and no branched diols, developed haze and were not shelf-stable for at least 6 months.

### Preparation of Foams

The B-side resin blend formulation used to prepare the polyurethane spray foams used in the following examples 5-7 is listed in Table 3:

TABLE 3
Formulation

| | |
|---|---|
| Polyester Polyol | 48.75% |
| Polyether Polyol 1 | 15.00% |
| Polyether Polyol 2 | 10.00% |
| Fyrol PCF | 4.00% |
| Saytex RB7980 | 10.00% |
| Water | 2.50% |
| Dabco DC 193 | 1.10% |
| Polycat 5 | 0.40% |
| Polycat 8 | 0.75% |
| Curithane 52 | 0.50% |
| HFC 245fa | 7.00% |
| Total | 100 |
| Index | 100 |

The B-side resin blends were made by blending each polyester polyol, flame retardant, catalysts, blowing agent, and auxiliary components together according to the formulation in Table 3. Polyurethane foams were produced from the reaction between the B-side resin blend and A-side isocyanate (MR Light, a 2.7-functional pMDI available from Bayer). The resin blend and isocyanate were combined at a ratio calculated from the formulation to give an index of about 100.

### Foam Flammability Tests

To produce foam samples for burn testing, the B-side resin was conditioned to 60° F. and the A-side isocyanate was conditioned to 25° C., and the A-side and B-side were combined and mixed for 3 seconds. The mixture was immediately poured into a 13″×5″×2″ mold, the surfaces of which were coated with mold release and heated to 40° C. The foam was demolded after 5 minutes and allowed to sit for a minimum of 24 hours prior to cutting. Samples were cut to 4″×5″×1.5″ for smoke and weight loss testing.

Smoke testing was done with internal equipment developed to measure the amount of smoke produced upon ignition via light obscuration. The amount of smoke generated is quantified and the weight loss of the sample during testing is measured. The results of the smoke testing show that Examples 6-7, made in accordance with the present technology, achieved low smoke generation and weight loss properties compared to Example 5, which used a control polyol with greater than or equal to 50 mol % ortho-phthalic acid. The results of the testing are shown in Table 4.

TABLE 4
Flammability Performance of Polyurethane
Foam with High Terephthalic Acid Content

| | | Quantified | % Smoke | | % Improvement in |
|---|---|---|---|---|---|
| | | Smoke | Improvement | % Weight | % Weight loss |
| Example | Polyol | Value | over PS-3024 | Loss | over PS-3024 |
| 5 | PS-3024 | 224 | — | 41 | — |
| 6 | Example 1 | 123 | 45.1 | 30 | 26.8 |
| 7 | Example 2 | 153 | 31.7 | 30 | 26.8 |

Closed-cell polyurethane-modified polyisocyanurate foams were produced in Examples 8-10, with comparative 4 from reaction between the B-side and the A-side polyisocyanate. B-side resin blends were made by blending each example polyol, flame retardant, surfactant, catalysts and blowing agents etc. The resin blend and polyisocyanate, at 20° C., were combined in a paper cup at a ratio calculated from the formulation to give the required index. 300 g total of polyisocyanate and B-side were combined and agitated for 6.5 seconds using a motor-driven mixing blade rotating at 3400 rpm, and the mixture was poured into a tared paper cup with volume of about 5 L for reactivity, density, green strength and compressive strength. Foam molds were made by pouring A and B mixture into a 25 in×13 in×2 in mold. Hot Plate and Thermogravity analysis (TGA), samples were cut from the panel.

For hot plate testing, a 4 inches×4 inches×1.25 inches sample was put on a hot plate at a temperature of 1200° F. and kept in place for 15 minutes. During that time, the temperature was gradually cooled from 1200° F. to 1000° F. using a programmed thermal controller. The weight and thickness change of the foam was measured and recorded afterwards. Volume expansion of the foam under thermal stress is preferable, and less weight loss is presumed to indicate a better flammability performance.

TGA Test Procedure: Thermogravimetric analysis was run using a Perkin Elmer Thermogravimetric Analyzer (PYRIS 1 TGA). The foam sample (1.5-3.0 mg) was placed under nitrogen (20 ml/min flow rate) and weighed on and extremely sensitive balance at 100° C. After an additional minute of equilibration the temperature was ramped from 100° C.-800° C. at a rate of 10° C./min while weight data (expressed as % weight loss) was collected as a function of temperature. Thermogravimetric analysis (TGA) is a widely accepted analytical technique that provides an indication of relative thermal stability for the material under consideration. Thermal stability is expressed as percent retention of foam weight at a particular temperature relative to the foam's initial weight at 100° C. The greater the temperature, the greater the extent of polymer decomposition, and the lower the percent weight retention. Higher weight retention is an indication of better thermal stability which is presumed to indicate better flammability performance.

Foam performances are listed in table 5.

TABLE 5
Flammability Performance of Polyurethane-modified Polyisocyanurate
Foam with High Terephthalic Acid Content

| | OHV | Comparative 4 | Example 8 | Example 9 | Example 10 |
|---|---|---|---|---|---|
| Stepanpol ®PS2352 | 240 | 100.00 | | | |
| Polyol 5 | 240 | | 100.00 | | 100 |
| Polyol 6 | 240 | | | 100 | |
| catalyst blend | 492 | 3.58 | 3.58 | 3.58 | 3.58 |
| Tegostab B 8465 | | 2.00 | 2.00 | 2.00 | 2.00 |
| Water | 6233 | 0.25 | 0.25 | 0.25 | 0.25 |
| Fyrol PCF | | 10.00 | 10.00 | | |
| Triethyl Phosphate (TEP)/ | | | | 10.00 | 10.00 |
| Fyrol PNX Blend | | | | | |
| n-pentane | | 24.00 | 24.00 | 24.00 | 24.00 |
| Total B | | 139.83 | 139.83 | 139.83 | 139.83 |
| Index | | 250 | 250 | 250 | 250 |
| Mondur ® M-489 | 135.55 | 165.03 | 165.03 | 165.03 | 165.03 |
| Reactivity (s) | | | | | |
| Cream time | | 13 | 13 | 10 | 10 |
| String gel | | 31 | 33 | 27 | 26 |
| Firm Gel | | 39 | 45 | 36 | 34 |
| Tack Free | | 50 | 53 | 41 | 41 |
| Density (PCF) | | 1.62 | 1.64 | 1.68 | 1.70 |
| Green strength @ 2 min (psi) | | 7.77 | 7.90 | 9.42 | 9.50 |
| Compressive strength (psi) | | 29.00 | 27.11 | 28.58 | 28.87 |
| Hot plate thickness change % | | −11.7% | 4.1% | 2.3% | 5.2% |
| TGA weight % retention @ | | 50.6 | 60.2 | 72.6 | 76.7 |
| 350 C. | | | | | |
| TGA weight % retention @ | | 36.9 | 43.6 | 43.3 | 44.8 |
| 500 C. | | | | | |

From the data above, it can be seen that polyols 5 and 6, containing greater than 50 mol % terephthalate, improved flammability of the foam, compared to comparative example 4, which used an all ortho-phthalic acid-based polyol. The foam in Examples 8-10, with terephthalate-based polyols, retained more weight in the TGA test, and had less thickness loss in hot plate test.

Closed-cell polyurethane-modified polyisocyanurate foams were produced in Examples 11-13, from the reaction between the B-side and the A-side polyisocyanate. B-side resin blends were made by blending each example polyol, flame retardant, surfactant, catalysts and blowing agents etc. The resin blend and polyisocyanate, at 20° C., were combined in a paper cup at a ratio calculated from the formulation to give the required index. 210 g total of polyisocyanate and B-side were combined and agitated for 8 seconds using a motor-driven mixing blade rotating at 3400 rpm, and the mixture was poured into a 25 in×13 in×2 in mold heated to 55° C. Molds were removed after 15 minutes and cured for 24 hours at 90° C. prior to cooling, cutting and testing. Smoke testing was done with internal equipment developed to measure the amount of smoke produced upon ignition via light obscuration. The amount of smoke generated is quantified and the weight loss of the sample during testing is measured. The results of the smoke testing show that Examples 12-13, made in accordance with the present technology, achieved low smoke generation and weight loss properties compared to Example 11, which used a control polyol with greater than or equal to 50 mol % ortho-phthalic acid.

| | Example 11 | Example 12 | Example 13 |
|---|---|---|---|
| PS-2352 | 100 | | |
| Polyol 1 | | 100 | |
| 50/50 weight blend of | | | 100 |
| Polyol 1 and Polyol 2 | | | |
| RB-7980 | 15.0 | 15.0 | 15.0 |
| Water | 0.4 | 0.4 | 0.4 |
| TMR-3 | 2.0 | 2.0 | 2.0 |
| Curithane 52 | 1.5 | 1.5 | 1.5 |
| Polycat 5 | 0.1 | 0.1 | 0.1 |
| B-8537 | 2.0 | 2.0 | 2.0 |
| n-Pentane | 22.0 | 22.0 | 22.0 |
| Total | 143 | 143 | 143 |
| Index | 300 | 300 | 300 |
| Mondur M489 | 250 | 250 | 250 |
| Quantified Smoke Value | | 94 | 108 |
| % Smoke Improvement | — | | |
| over PS-2352 | | | |
| % Weight Loss | | 22 | 22 |
| % Improvement in % Weight | — | | |
| Loss over PS-2352 | | | |

The present technology is now described in such full, clear, concise and exact terms as to enable a person skilled in the art to which it pertains, to practice the same. It is to be understood that the foregoing describes preferred embodiments of the present technology and that modifications may be made therein without departing from the spirit or scope of the present technology, as set forth in the appended claims.

What is claimed is:

1. A foam-forming composition comprising:
at least one diisocyanate component, at least one polyisocyanate component, or mixtures thereof, and
a resin blend that comprises
(A) 40% to 80% by weight of the resin blend of a polyester polyol that is the esterification reaction product of
(i) a phthalate-based composition comprising less than 50 mol % of ortho-phthalic acid or ortho-phthalic anhydride and greater than 50 mol % of one or more of terephthalic acid, isophthalic acid, and dimethyl terephthalate; and
(ii) a hydroxyl-containing composition comprising
(a) from 20 mol % to 80 mol % of at least one branched aliphatic diol;
(b) diethylene glycol and optionally, one or more additional polyols selected from the group consisting of ethylene glycol, triethylene glycol, 1,3-propane glycol, butylene glycols, 1,2-cyclohexane diol, glycerol, 1,1,1-trimethylol propane, 1,1,1-trimethylolethane, and pentaerythritol;
0 to 2 mol % of at least one hydrophobic material transesterified with the esterification reaction product;
wherein the aromatic polyester polyol has an OH value of 250 to 350 mg KOH/g, wherein the aromatic polyester polyol has a functionality of 1.8 to 2.2, and an Acid Value of 0.25 to 3.0 mg KOH/g, and wherein the aromatic polyester polyol remains clear and homogeneous for a period of at least 6 months when stored at 25° C.
(B) optionally, a nonionic surfactant blended with the polyester polyol;
(C) at least one blowing agent;
(D) optionally, at least one catalyst;
(E) optionally, at least one flame retardant; and
(F) optionally, at least one additive selected from fillers, pigments and surfactants.
wherein the isocyanate and the resin blend are combined at an isocyanate index of about 90 to about 150.

2. The foam-forming composition of claim 1, wherein the flame retardant comprises at least one chlorinated phosphate.

3. The foam-forming composition of claim 1, wherein the flame retardant comprises at least one non-halogenated phosphate.

4. The foam-forming composition of claim 1, wherein the isocyanate comprises a polymeric diphenylmethane diisocyanate (MDI) having a nominal functionality of about 2.7-3.0 and an NCO content of about 31 weight percent.

5. The foam-forming composition of claim 1, wherein the branched aliphatic diol is 2-methyl-1,3-propandiol.

6. The foam-forming composition of claim 5, wherein the aromatic polyester polyol remains clear and homogeneous for a period of at least 9 months when stored at 25° C.

7. The foam-forming composition of claim 5, wherein the aromatic polyester polyol remains clear and homogeneous for a period of at least one year when stored at 25° C.

8. A foam prepared from the foam forming composition of claim 1, wherein the foam formed is a polyurethane foam.

9. The foam of claim 8, wherein the foam exhibits at least a 10% improvement in weight loss during smoke testing compared to a foam prepared from a polyester polyol comprising greater than 50 mol % of ortho-phthalate or phthalic anhydride.

10. The foam of claim 8, wherein the foam exhibits less smoke generation during smoke testing compared to a foam prepared from a polyester polyol comprising greater than 50 mol % of ortho-phthalate or phthalic anhydride.

11. A foam-forming composition comprising:
at least one diisocyanate component, at least one polyisocyanate component, or mixtures thereof, and
a resin blend that comprises
(A) 40% to 80% by weight of the resin blend of a polyester polyol that is the esterification reaction product of
(i) a phthalate-based composition comprising less than 50 mol % of ortho-phthalic acid or ortho-phthalic anhydride and greater than 50 mol % of one or more of terephthalic acid, isophthalic acid, and dimethyl terephthalate; and
(ii) a hydroxyl-containing composition comprising
(a) from 20 mol % to 80 mol % of 2-methyl-1,3-propandiol;
(b) diethylene glycol and optionally, one or more additional polyols selected from the group consisting of ethylene glycol, triethylene glycol, 1,3-propane glycol, butylene glycols, 1,2-cyclohexane diol, glycerol, 1,1,1-trimethylol propane, 1,1,1-trimethylolethane, and pentaerythritol;
0 to 2 mol % of at least one hydrophobic material transesterified with the esterification reaction product;
wherein the aromatic polyester polyol has an OH value of 250 to 350 mg KOH/g, wherein the aromatic polyester polyol has a functionality of 1.8 to 2.2, and an Acid Value of 0.25 to 3.0 mg KOH/g, and wherein the aromatic polyester polyol remains clear and homogeneous for a period of at least 6 months when stored at 25° C.
(B) optionally, a nonionic surfactant blended with the polyester polyol;
(C) at least one blowing agent;
(D) optionally, at least one catalyst;
(E) optionally, at least one flame retardant; and
(F) optionally, at least one additive selected from fillers, pigments and surfactants.
wherein the isocyanate and the resin blend are combined at an isocyanate index of about 90 to about 150.

12. The foam-forming composition of claim 11, wherein the flame retardant comprises at least one chlorinated phosphate.

13. The foam-forming composition of claim 11, wherein the flame retardant comprises at least one non-halogenated phosphate.

14. The foam-forming composition of claim 11, wherein the isocyanate comprises a polymeric diphenylmethane diisocyanate (MDI) having a nominal functionality of about 2.7-3.0 and an NCO content of about 31 weight percent.

15. The foam-forming composition of claim 11, wherein the aromatic polyester polyol remains clear and homogeneous for a period of at least 9 months when stored at 25° C.

16. The foam-forming composition of claim 11, wherein the aromatic polyester polyol remains clear and homogeneous for a period of at least one year when stored at 25° C.
